(19) United States
(12) Patent Application Publication
(10) Pub. No.: US 2007/0258179 A1
(43) Pub. Date: Nov. 8, 2007

(54) Power supply device having surge protection function

(76) Inventor: Seong-hee Yoon, Daegu (KR)

Correspondence Address: RABIN & Berdo, PC, 1101 14TH STREET, NW, SUITE 500, WASHINGTON, DC, 20005, US

(21) Appl. No.: 11/415,068

(22) Filed: May 2, 2006

(51) Int. Cl. H02H 9/06

(52) U.S. Cl. 361/118

(57) ABSTRACT

A power supply device having a surge protection function is provided. The power supply device includes: a rectifier for rectifying an AC voltage; an arc current detector for detecting a surge current from the rectified voltage; a band pass filter for band-pass-filtering the detected surge current; an arc pulse charging/discharging unit for receiving the band-pass-filtered voltage and charging/discharging an arc pulse, thereby outputting a stable voltage; an arc pulse integrator for integrating the output voltage of the arc pulse charging/discharging unit; an SCR driving voltage shaping unit for performing a waveform shaping of the integrated voltage to output an SCR driving signal; an SCR driven in response to the SCR driving signal to output a power off control signal; a relay for interrupting the AC power by the driving of the SCR; and a surge protection unit for controlling a surge voltage generated from the rectified voltage and outputting stable driving voltage to the arc pulse charging/discharging unit and the arc pulse integrator.

### BACKGROUND OF THE INVENTION

1Field of the Invention

The present invention relates to a power supply device, and more particularly, to a power supply device having a surge protection function, in which a surge voltage is controlled by interrupting the supply of an AC power when an overvoltage is detected from a rectified external AC voltage.

2Description of the Related Art Generally, an inverter is a conversion circuit that converts an AC voltage into a high-efficiency DC power. Specifically, the inverter varies a frequency and voltage during the conversion operation.

Such an inverter is widely applied in high-capacity household appliances, such as industrial equipment and air conditioner, which need to control a torque.

A simple diode bridge circuit is used to convert the AC voltage into the DC voltage, and a large-capacity smoothing condenser is used to remove a voltage ripple after the rectification.

One of the various application fields of the inverter is a multi-articulated robot field. The inverter drives a motor provided at each axle of the multi-articulated robot. As can be known from the term “multi-articulated robot”, the multi-articulated robot has several axles, and the motor and the inverter for controlling the motor are provided at each axle.

Meanwhile, a protection device capable of protecting the inverter from an overvoltage or the like is required for the stable operation of the inverter. Generally, the protection device, that is, an active power module, is separately provided at a power input terminal of the inverter.

However, the conventional power supply device capable of protecting the inverter from the surge voltage uses two rectifiers to configure a closed circuit with a frame ground and an AC Hot or Neu circuit. A varistor is disposed between a ground terminal and a power terminal of a relay that controls an overcurrent, so that a proper control of the surge current cannot be achieved. Also, in the fabrication of the product, the number of elements increases and thus a manufacturing cost increases.

### SUMMARY OF THE INVENTION

An object of the present invention is to provide a power supply device having a surge protection function, in which a surge voltage and a surge current can be controlled using a varistor disposed on both AC terminals, without using a frame ground, thereby simplifying the circuit configuration.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a power supply device having a surge protection function according to an embodiment of the present invention; and

FIG. 2 is a circuit diagram of the power supply voltage illustrated in FIG. 1.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

To achieve the object of the present invention, a power supply device having a surge protection function includes: a rectifier for rectifying an AC voltage; an arc current detector for detecting a surge current from the rectified voltage; a band pass filter (BPF) for band-pass-filtering the detected surge current; an arc pulse charging/discharging unit for receiving the band-pass-filtered voltage and charging/discharging an arc pulse, thereby outputting a stable voltage; an arc pulse integrator for integrating the output voltage of the arc pulse charging/discharging unit; an SCR driving voltage shaping unit for performing a waveform shaping of the integrated voltage to output an SCR driving signal; an SCR driven in response to the SCR driving signal to output a power off control signal; a relay for interrupting the AC power by the driving of the SCR; and a surge protection unit for controlling a surge voltage generated from the rectified voltage and outputting stable driving voltage to the arc pulse charging/discharging unit and the arc pulse integrator.

The power supply device further includes a test switch connected to the SCR driving voltage shaping unit to test whether the device operates normally.

The preferred embodiments of the present invention will be described below in detail with reference to the accompanying drawings.

In addition, a detailed description of well-known features will be omitted for conciseness.

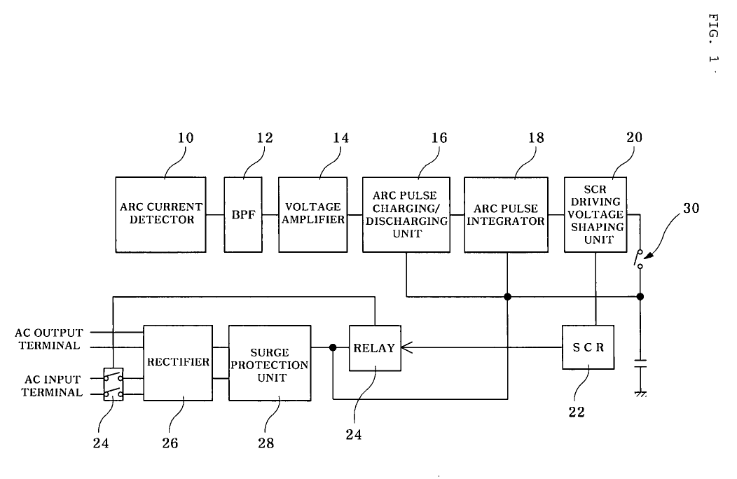

FIG. 1 is a block diagram of a power supply device having a surge protection function according to an embodiment of the present invention.

Referring to FIG. 1, the power supply device includes a rectifier 26 for rectifying an input AC voltage, an arc current detector (ZCT) 10 for detecting a surge current from the rectified voltage, a band pass filter 12 for band-pass-filtering the surge current detected by the arc current detector 10, a voltage amplifier 14 for amplifying the filtered voltage to a predetermined level, an arc pulse charging/discharging unit 16 for receiving the amplified voltage from the voltage amplifier 14 and charging/discharging an arc pulse to output a stable voltage, an arc pulse integrator 18 for integrating the output voltage of the arc pulse charging/discharging unit 16, an SCR driving voltage shaping unit 20 for performing a waveform shaping of the integrated voltage to output an SCR driving signal, an SCR 22 for outputting a power off control signal in response to the SCR driving signal outputted from the SCR driving voltage shaping unit 20, a relay 24 for interrupting the input AC voltage by the driving of the SCR 22, and a surge protection unit 28 for controlling a surge voltage generated from the voltage rectified by the rectifier 26 and outputting a stable driving voltage.

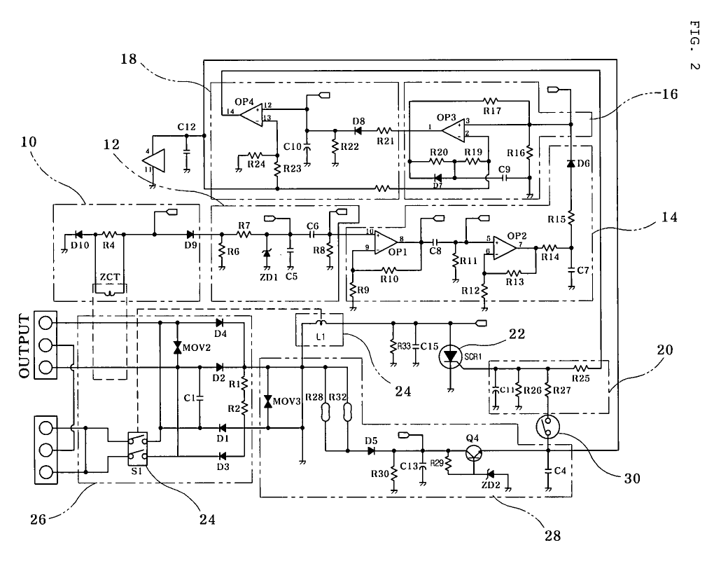

FIG. 2 is a circuit diagram of the power supply voltage illustrated in FIG. 1.

Referring to FIG. 2, the arc current detector 10 is connected to the rectifier 26 and includes a zero-phase current transformer (ZCT), a resistor R4, and diodes D9 and D10.

The band pass filter 12 is connected to the arc current detector 10 and includes resistors R6 and R7, a zener diode ZD1, and capacitors C5 and C6.

The voltage amplifier 14 is connected to the band pass filter 12 and includes operational amplifiers OP1 and OP2, resistors R9 to R15, and capacitors C7 and C8.

The arc pulse charging/discharging unit 16 is connected to the voltage amplifier 14 and includes a diode D7, an operational amplifier OP3, and resistors R16 to R20.

The arc pulse integrator 18 is connected to the arc pulse charging/discharging unit 16 and includes resistors R21 to R24, a diode D8, a capacitor C10, and an operational amplifier OP4.

The SCR driving voltage shaping unit 20 is connected to the arc pulse integrator 18 and includes resistors R25 to R27 and a capacitor C11.

The rectifier 26 includes a varistor MOV2, diodes D1 to D4, a capacitor C1, and resistors R1 and R2.

The surge protection unit 28 includes a varistor MOV3, a capacitor C13, resistors R28 to R30, a capacitor C4, a transistor Q4, a zener diode ZD2, and a diode D5.

An operation of the power supply device according to the present invention will be described below in detail with reference to FIGS. 1 and 2.

An input AC voltage is applied to the rectifier 26 through a switch S1 of the relay 24. The rectifier 26 rectifies the AC voltage through the diodes Dl to D4 and supplies the rectified voltage through the AC output terminal to the load. The rectified voltage from the rectifier 26 is applied to the surge protection unit 28. When the surge voltage is generated from the rectified voltage, the surge protection unit 28 passes the surge voltage through the zener diode ZD2 such that a constant voltage is outputted through the transistor Q4. The constant voltage is applied to the arc pulse charging/discharging unit 16 and the arc pulse integrator 18.

Meanwhile, if a surge current flows when the rectified voltage from the rectifier 26 is outputted through the AC output terminal, magnetic flux is generated in the zero-phase current transformer (ZCT) due to the current and thus the voltage is detected from the resistor R4. The detected voltage from the resistor R4 is band-pass-filtered by the band pass filter 12, which is configured with the resistors R6 to R8, the zener diode ZD1, and the capacitor C5.

The filtered voltage is primarily amplified by the amplifier, which is configured with the resistors R9 and R10 and the operational amplifier OPl. Then, the primarily amplified voltage from the operational amplifier OP1 is secondarily amplified through the resistors R11 to R15, the capacitors C7 and C8, and the operational amplifier OP2.

The secondarily amplified voltage from the operational amplifier OP2 is applied to the arc pulse charging/discharging unit 16 and then is outputted as a stable voltage by the repetitive charging/discharging operations of the arc pulse charging/discharging unit 16, which is configured with the resistors R16 to R20, the capacitor C9, the diode D7, and the operational amplifier OP3.

The voltage from the operational amplifier OP3 is integrated by the arc pulse integrator 18, which is configured with the resistors R21 to R24, the capacitor C10, the diode D8, and the operational amplifier OP4, and then the integrated voltage is applied to the SCR driving voltage shaping unit 20. The SCR driving voltage shaping unit 20 is configured with the resistors R25 and R26 and the capacitor C11. The SCR driving voltage shaping unit 20 performs a waveform shaping of the integrated voltage. The shaped voltage is applied to the SCR 22 so that the SCR 22 is turned on.

When the SCR 22 is turned on, a current flows through a coil L1 of the relay 24 and the switch S1 of the relay 24 is turned off, so that the external AC voltage is interrupted.

Accordingly, when the surge voltage is generated from the rectified voltage outputted from the rectifier 26, the supply of power is interrupted so that the surge voltage is controlled.

A test switch 30 is provided for testing whether the device operates normally.

As described above, when the operating voltage is supplied through the inverter, the surge current is detected and the supply of power is interrupted. Therefore, the circuit can be protected from the overvoltage or surge voltage. The varistor is used on both terminals of the primarily inputted AC voltage, and the secondarily rectified voltage passes through the diode and the varistor. The surge current generated from the rectified voltage is detected. Consequently, the circuit configuration can be simplified.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A power supply device having a surge protection function, comprising:
a rectifier for rectifying an AC voltage;
an arc current detector for detecting a surge current from the rectified voltage;
a band pass filter for band-pass-filtering the detected surge current;
an arc pulse charging/discharging unit for receiving the band-pass-filtered voltage and charging/discharging an arc pulse, thereby outputting a stable voltage;
an arc pulse integrator for integrating the output voltage of the arc pulse charging/discharging unit;
an SCR driving voltage shaping unit for performing a waveform shaping of the integrated voltage to output an SCR driving signal;
an SCR driven in response to the SCR driving signal to output a power off control signal;
a relay for interrupting the AC power by the driving of the SCR; and
a surge protection unit for controlling a surge voltage generated from the rectified voltage and outputting stable driving voltage to the arc pulse charging/discharging unit and the arc pulse integrator.

2. The power supply device of claim 1, further comprising a test switch connected to the SCR driving voltage shaping unit to test whether the device operates normally.
